(19) United States
(12) Patent Application Publication
(10) Pub. No.: US 2020/0343583 A1
(43) Pub. Date: Oct. 29, 2020

(54) ALL-SOLID-STATE BATTERY AND METHOD FOR PRODUCING THE SAME

(71) Applicant: TOYOTA JIDOSHA KABUSHIKI KAISHA, Toyota-shi (JP)

(72) Inventors: Ximeng LI, Susono-shi (JP); Masumi SATO, Susono-shi (JP); Masafumi NOSE, Susono-shi (JP)

(21) Appl. No.: 16/853,881

(22) Filed: Apr. 21, 2020

(30) Foreign Application Priority Data
Apr. 26, 2019 (JP) 2019-086447
Aug. 30, 2019 (JP) 2019-158346

(51) Int. Cl. H01M 10/0562; H01M 10/0525; H01M 10/44; H01M 4/134; H01M 4/66

(52) U.S. Cl. CPC H01M 10/0562; H01M 10/0525; H01M 2004/021; H01M 4/134; H01M 4/667; H01M 10/44

(57) ABSTRACT

Provided is an all-solid-state battery with high charge-discharge efficiency, and a method for producing the all-solid-state battery. Disclosed is an all-solid-state battery, wherein a lithium metal precipitation-dissolution reaction is used as an anode reaction; wherein the all-solid-state battery comprises a cathode comprising a cathode layer, an anode comprising an anode current collector and an anode layer, and a solid electrolyte layer disposed between the cathode layer and the anode layer; wherein the anode layer contains, as an anode active material, a single β-phase alloy of a lithium metal and a magnesium metal; and wherein a percentage of the lithium element in the alloy is 81.80 atomic % or more and 99.97 atomic % or less when the all-solid-state battery is fully charged.

### TECHNICAL FIELD

The disclosure relates to an all-solid-state battery and a method for producing the all-solid-state battery.

### BACKGROUND

In recent years, with the rapid spread of IT and communication devices such as personal computers, camcorders and cellular phones, great importance has been attached to the development of batteries that is usable as the power source of such devices. In the automobile industry, etc., high-power and high-capacity batteries for electric vehicles and hybrid vehicles are under development.

Of various kinds of batteries, a lithium secondary battery has attracted attention for the following reasons: since it uses lithium, which is a metal having the largest ionization tendency, as the anode, the potential difference between the cathode and the anode is large, and high output voltage is obtained.

Also, an all-solid-state battery has attracted attention, since it uses a solid electrolyte as the electrolyte present between the cathode and the anode, in place of a liquid electrolyte containing an organic solvent.

Patent Literature 1 discloses a battery in which a layer containing one or more elements selected from the group consisting of Cr, Ti, W, C, Ta, Au, Pt, Mn and Mo is arranged between a collector foil and an electrode body.

Patent Literature 2 discloses a solid battery in which a metal oxide layer containing an oxide of at least one metal element selected from the group consisting of Cr, In, Sn, Zn, Sc, Ti, V, Mn, Fe, Co, Ni, Cu and W, is formed at least on an interface between a current collector and a cathode and/or anode adjacent to the current collector.

Patent Literature 1: Japanese Patent Application Laid-Open (JP-A) No. 2012-049023

Patent Literature 2: JP-A No. 2009-181901

An all-solid-state battery in which the anode contains a lithium metal, has the following problem: even if the all-solid-state battery has a conventionally-known battery structure, the charge-discharge efficiency of the all-solid-state battery is low.

### SUMMARY

In light of the above circumstances, an object of the disclosed embodiments is to provide an all-solid-state battery with high charge-discharge efficiency. Another object of the disclosed embodiments is to provide a method for producing the all-solid-state battery.

In a first embodiment, there is provided an all-solid-state battery,

wherein a lithium metal precipitation-dissolution reaction is used as an anode reaction;

wherein the all-solid-state battery comprises a cathode comprising a cathode layer, an anode comprising an anode current collector and an anode layer, and a solid electrolyte layer disposed between the cathode layer and the anode layer;

wherein the anode layer contains, as an anode active material, a single β-phase alloy of a lithium metal and a magnesium metal; and

wherein a percentage of the lithium element in the alloy is 81.80 atomic % or more and 99.97 atomic % or less when the all-solid-state battery is fully charged.

In a second embodiment, there is provided a method for producing the all-solid-state battery, the method comprising:

forming a Mg metal layer containing a magnesium metal on one surface of the anode current collector or on one surface of the solid electrolyte layer,

forming a battery precursor comprising the anode current collector, the Mg metal layer, the solid electrolyte layer and a cathode layer in this order, the cathode layer containing a cathode active material containing a lithium element, and

charging the battery precursor to form the Mg metal layer into a Li—Mg alloy layer containing a single β-phase alloy of a lithium metal and a magnesium metal.

In another embodiment, there is provided a method for producing the all-solid-state battery, the method comprising:

forming a Li—Mg alloy layer on one surface of the anode current collector or on one surface of the solid electrolyte layer, the Li—Mg alloy layer containing a single β-phase alloy of a lithium metal and a magnesium metal, and

disposing the anode current collector, the Li—Mg alloy layer, the solid electrolyte layer, and a cathode layer containing a cathode active material in this order.

In the all-solid-state battery production method of the disclosed embodiments, a percentage of the lithium element in the alloy may be 96.92 atomic % or more and 99.97 atomic % or less.

The percentage of the lithium element in the alloy may be 81.80 atomic % or more and 99.80 atomic % or less.

The thickness of the Mg metal layer may be from 100 nm to 1000 nm.

According to the disclosed embodiments, an all-solid-state battery with high charge-discharge efficiency and a method for producing the all-solid-state battery, are provided.

### BRIEF DESCRIPTION OF THE DRAWINGS

In the accompanying drawings,

FIG. 1 is a schematic sectional view of an example of the all-solid-state battery of the disclosed embodiments when the battery is fully charged, and

FIG. 2 is a phase diagram for a Li—Mg binary alloy.

### DETAILED DESCRIPTION

### 1. All-Solid-State Battery

The all-solid-state battery of the disclosed embodiments is an all-solid-state battery,

wherein a lithium metal precipitation-dissolution reaction is used as an anode reaction;

wherein the all-solid-state battery comprises a cathode comprising a cathode layer, an anode comprising an anode current collector and an anode layer, and a solid electrolyte layer disposed between the cathode layer and the anode layer;

wherein the anode layer contains, as an anode active material, a single β-phase alloy of a lithium metal and a magnesium metal; and

wherein a percentage of the lithium element in the alloy is 81.80 atomic % or more and 99.97 atomic % or less when the all-solid-state battery is fully charged.

In the disclosed embodiments, “lithium secondary battery” means a battery in which at least one of a lithium metal and a lithium alloy is used as the anode active material and a lithium metal precipitation-dissolution reaction is used as an anode reaction.

In the disclosed embodiments, “when the all-solid-state battery is fully charged” means that the SOC (state of charge) value of the all-solid-state battery is 100%. The SOC means the percentage of the charge capacity with respect to the full charge capacity of the battery. The full charge capacity is a SOC of 100%.

For example, the SOC may be estimated from the open circuit voltage (OCV) of the all-solid-state battery.

A conventional all-solid-state lithium secondary battery has a problem in that irreversible lithium metal precipitation occurs in each charge-discharge cycle and results in low charge-discharge efficiency. This is because, since the lithium metal is non-uniformly dissolved, part of ion conducting paths are blocked, and part of the lithium metal cannot be dissolved. In the disclosed embodiments, the anode layer containing, as the anode active material, the single β-phase alloy of the lithium metal and the magnesium metal is used, thereby providing an all-solid-state battery with high charge-discharge efficiency, in which lithium ions are uniformly diffused when the all-solid-state battery is charged and discharged.

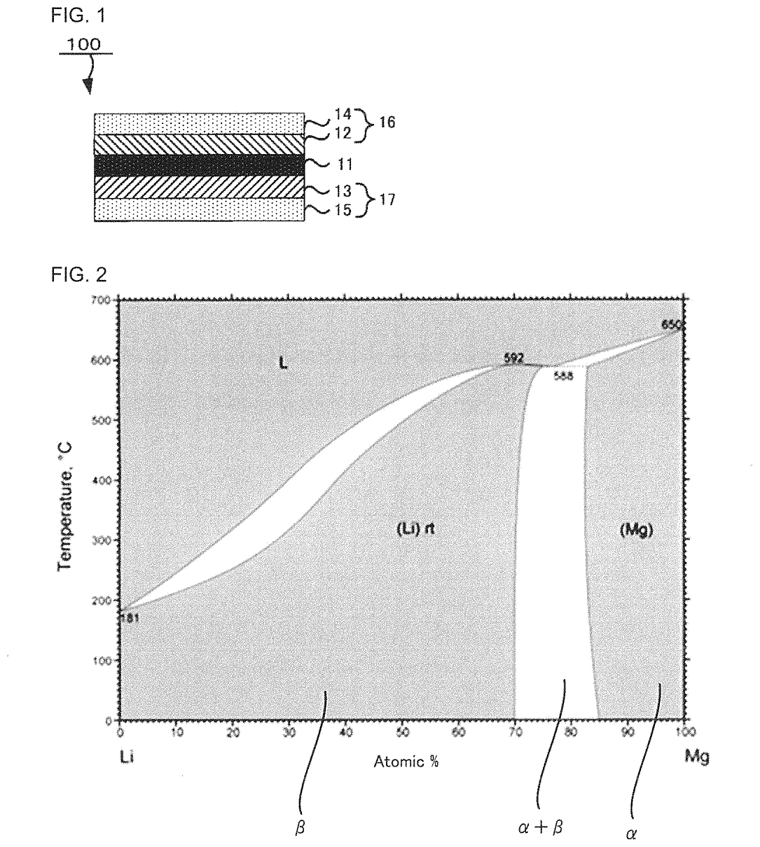

FIG. 1 is a schematic sectional view of an example of the all-solid-state battery of the disclosed embodiments when the battery is fully charged.

As shown in FIG. 1, an all-solid-state battery 100 comprises a cathode 16 comprising a cathode layer 12 and a cathode current collector 14, an anode 17 comprising an anode layer 13 and an anode current collector 15, and a solid electrolyte layer 11 disposed between the cathode layer 12 and the anode layer 13.

### Anode

The anode comprises an anode layer and an anode current collector.

The anode layer contains an anode active material.

As the anode active material, examples include, but are not limited to, a single β-phase alloy of a lithium metal and a magnesium metal. FIG. 2 is a phase diagram for a Li—Mg binary alloy.

In the disclosed embodiments, the single β-phase alloy means an alloy of a lithium metal and a magnesium metal at a ratio in the region indicated by “β” (β phase) in FIG. 2.

As shown in FIG. 2, a single-phase (β-phase) alloy of a lithium metal and a magnesium metal is suggested to be obtained in the region where the percentage of the lithium element at 0° C. is 30 atomic % or more.

In the single-phase alloy, the lithium element and the magnesium element can be mutually diffused without limits, and they are uniformly distributed.

Accordingly, the lithium metal of the alloy can be uniformly dissolved, and the dissolution rate of the lithium metal of the alloy when the all-solid-state battery is discharged, can be accelerated.

Confirmation of whether the alloy is a single β-phase alloy or not, can be carried out by analyzing the alloy by XRD or the like, calculating the percentage of any element in the alloy, and matching the thus-obtained result to FIG. 2.

The β-phase alloy has the same crystal structure as the lithium metal. Meanwhile, the a phase alloy shown in FIG. 2 has the same crystal structure as the magnesium metal. Accordingly, as long as the crystal structure of the alloy is the same as that of the lithium metal, the alloy can be determined as the β-phase alloy.

Also, the alloy can be determined as the single-phase alloy, as long as no phase separation is found to occur in the alloy by electron microscopy observation.

The percentage of the lithium element in the alloy when the all-solid-state battery is fully charged, may be 30.00 atomic % or more and 99.97 atomic % or less; it may be 81.80 atomic % or more and 99.80 atomic % or less; it may be 96.80 atomic % or more and 99.97 atomic % or less from the viewpoint of further increasing the charge-discharge efficiency of the all-solid-state battery; or it may be 96.92 atomic % or more and 99.97 atomic % or less. The percentage of any element in the alloy may be calculated by analyzing the alloy by inductively-coupled plasma (ICP) analysis or X-ray photoelectron spectroscopy (XPS). Also, the percentage of any element in the alloy may be calculated from the atomic weights of the elements contained in the alloy and the amount of change in the mass of the alloy with respect to raw materials. For example, the percentage of the lithium element in the alloy may be calculated by the following method: when the all-solid-state battery is in a fully charged state, the anode layer is taken out from the all-solid-state battery and analyzed by ICP spectroscopy, and then the percentage of the lithium element in the alloy contained in the anode layer is calculated, thereby calculating the percentage of the lithium element in the alloy.

As long as the single β-phase alloy of the lithium metal and the magnesium metal is contained as an anode active material and as a main component in the anode layer of the disclosed embodiments, another conventionally-known anode active material may be contained. In the disclosed embodiments, the “main component” means a component that accounts for 50 mass % or more of the total mass of the anode layer.

The thickness of the anode layer is not particularly limited. It may be 30 nm or more and 5000 nm or less.

The method for forming the anode layer may be the following method, for example.

First, using an electron beam evaporation device, a magnesium metal layer is formed by vacuum deposition of the magnesium metal on one surface of the solid electrolyte layer or anode current collector. Then, a cathode layer containing at least one kind of cathode active material selected from the group consisting of a lithium metal, a lithium alloy and a lithium compound, is prepared. The cathode layer, the solid electrolyte layer, the magnesium metal layer and the anode current collector are disposed in this order to prepare a battery precursor. By charging the battery precursor, lithium ions are transferred from the cathode layer to the magnesium metal layer and reacted with the magnesium metal of the magnesium metal layer. By this reaction, the anode layer containing the single β-phase alloy of the lithium metal and the magnesium metal is formed on the magnesium metal layer-side surface of the solid electrolyte layer. Accordingly, the anode layer is obtained. From the viewpoint of alloying all of the magnesium metal of the magnesium metal layer with the lithium metal, the battery precursor may be charged and discharged several times. The number of charging and discharging of the battery precursor is not particularly limited, and it may be appropriately determined depending on the thickness of the magnesium metal layer.

The anode current collector may be a material that is not alloyed with Li. As the material, examples include, but are not limited to, SUS, copper and nickel. As the form of the anode current collector, examples include, but are not limited to, a foil form and a plate form. The form of the anode current collector when being viewed from above is not particularly limited. As the anode current collector form when being viewed from above, examples include, but are not limited to, a circular form, an elliptical form, a rectangular form and various kinds of polygonal forms. The thickness of the anode current collector varies depending on the form of the anode current collector. For example, the thickness of the anode current collector may be in a range of from 1 μm to 50 μm, or it may be in a range of from 5 μm to 20 μm.

The thickness of the whole anode is not particularly limited.

### Cathode

The cathode comprises the cathode layer. As needed, it comprises a cathode current collector.

The cathode layer contains the cathode active material. As optional components, the cathode layer may contain a solid electrolyte, an electroconductive material and a binder, for example.

The type of the cathode active material is not particularly limited. The cathode active material can be any type of material that is usable as an active material for all-solid-state batteries. The cathode active material may be a cathode active material containing a lithium element, or it may be a cathode active material not containing a lithium element.

As the cathode active material containing the lithium element, examples include, but are not limited to, a lithium metal (Li) , a lithium alloy, LiCoO₂, LiNiₓCo₁₋ₓO₂ (0<x<1), LiNi_{1/3}Co_{1/3}Mn_{1/3}O₂, LiMnO₂, different element-substituted Li—Mn spinels (such as LiMn_{1.5}Co_{0.5}O₄, LiMn_{1.5}Fe_{0.5}O₄, LiMn_{1.5}Mg_{0.5}O₄, LiMn_{1.5}Co_{0.5}O₄, LiMn_{1.5}Fe_{0.5}O₄ and LiMn_{1.5}Zn_{0.5}O₄), lithium titanates (such as Li₄Ti₅O₁₂), lithium metal phosphates (such as LiFePO₄, LiMnPO₄, LiCoPO₄ and LiNiPO₄), LiCoN, Li₂SiO₃ and Li₄SiO₄.

As the cathode active material not containing the lithium element, examples include, but are not limited to, transition metal oxides (such as V₂O₅ and MoO₃), sulfur, TiS₂, Si, SiO₂ and lithium storage intermetallic compounds (such as Mg₂Sn, Mg₂Ge, Mg₂Sb and Cu₃Sb).

As the lithium alloy, examples include, but are not limited to, Li—Au, Li—Mg, Li—Sn, Li—Si, Li—Al, Li—Ge, Li—Sb, Li—B, Li—C, Li—Ca, Li—Ga, Li—As, Li—Se, Li—Ru, Li—Rh, Li—Pd, Li—Ag, Li—Cd, Li—Ir, Li—Pt, Li—Hg, Li—Pb, Li—Bi, Li—Zn, Li—Tl, Li—Te, Li—At and Li—In.

The form of the cathode active material is not particularly limited. It may be a particulate form.

A coating layer containing a Li ion conducting oxide, may be formed on the surface of the cathode active material. This is because a reaction between the cathode active material and the solid electrolyte can be suppressed.

As the Li ion conducting oxide, examples include, but are not limited to, LiNbO₃, Li₄Ti₅O₁₂ and Li₃PO₄. The thickness of the coating layer is 0.1 nm or more, for example, and it may be 1 nm or more. On the other hand, the thickness of the coating layer is 100 nm or less, for example, and it may be 20 nm or less. Also, for example, 70% or more or 90% or more of the cathode active material surface may be coated with the coating layer.

The content of the solid electrolyte in the cathode layer is not particularly limited. When the total mass of the cathode layer is determined as 100 mass %, the content of the solid electrolyte may be in a range of from 1 mass % to 80 mass %, for example.

As the solid electrolyte, examples include, but are not limited to, an oxide-based solid electrolyte and a sulfide-based solid electrolyte.

As the sulfide-based solid electrolyte, examples include, but are not limited to, Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅ and Li₃PS₄. The “Li₂S—P₂S₅” means a material composed of a raw material composition containing Li₂S and P₂S₅, and the same applies to other solid electrolytes. Also, “X” in the “LiX” means a halogen element. The LiX contained in the raw material composition may be one or more kinds. When two or more kinds of LiX are contained in the raw material composition, the mixing ratio is not particularly limited.

The molar ratio of the elements in the sulfide-based solid electrolyte can be controlled by controlling the contents of the elements contained in raw materials. The molar ratio and composition of the elements in the sulfide-based solid electrolyte can be measured by inductively coupled plasma atomic emission spectroscopy, for example.

The sulfide-based solid electrolyte may be sulfide glass, crystallized sulfide glass (glass ceramics) or a crystalline material obtained by developing a solid state reaction of the raw material composition.

The crystal state of the sulfide-based solid electrolyte can be confirmed by X-ray powder diffraction measurement using CuKa radiation, for example.

The sulfide glass can be obtained by amorphizing a raw material composition (such as a mixture of Li₂S and P₂S₅). The raw material composition can be amorphized by mechanical milling, for example. The mechanical milling may be dry mechanical milling or wet mechanical milling. The mechanical milling may be the latter because attachment of the raw material composition to the inner surface of a container, etc., can be prevented.

The mechanical milling is not particularly limited, as long as it is a method for mixing the raw material composition by applying mechanical energy thereto. The mechanical milling may be carried out by, for example, a ball mill, a vibrating mill, a turbo mill, mechanofusion, or a disk mill. The mechanical milling may be carried out by a ball mill, or it may be carried out by a planetary ball mill. This is because the desired sulfide glass can be efficiently obtained.

The glass ceramics can be obtained by heating the sulfide glass, for example.

For the heating, the heating temperature may be a temperature higher than the crystallization temperature (Tc) of the sulfide glass, which is a temperature observed by thermal analysis measurement. In general, it is 195° C. or more. On the other hand, the upper limit of the heating temperature is not particularly limited.

The crystallization temperature (Tc) of the sulfide glass can be measured by differential thermal analysis (DTA).

The heating time is not particularly limited, as long as the desired crystallinity of the glass ceramics is obtained. For example, it is in a range of from one minute to 24 hours, or it may be in a range of from one minute to 10 hours.

The heating method is not particularly limited. For example, a firing furnace may be used.

As the oxide-based solid electrolyte, examples include, but are not limited to, Li_{6.25}La₃Zr₂Al_{0.25}O₁₂, Li₃PO₄, and Li₃₊ₓPO₄₋ₓNₓ (1≤x≤3).

From the viewpoint of handling, the form of the solid electrolyte may be a particulate form.

The average particle diameter (D₅₀) of the solid electrolyte particles is not particularly limited. The lower limit may be 0.5 μm or more, and the upper limit may be 2 μm or less.

As the solid electrolyte, one or more kinds of solid electrolytes may be used. In the case of using two or more kinds of solid electrolytes, they may be mixed together.

In the disclosed embodiments, unless otherwise noted, the average particle diameter of particles is a volume-based median diameter (D₅₀) measured by laser diffraction/scattering particle size distribution measurement. Also in the disclosed embodiments, the median diameter (D₅₀) of particles is a diameter at which, when particles are arranged in ascending order of their particle diameter, the accumulated volume of the particles is half (50%) the total volume of the particles (volume average diameter).

As the electroconductive material, a known electroconductive material may be used. As the electroconductive material, examples include, but are not limited to, a carbonaceous material and metal particles. The carbonaceous material may be at least one selected from the group consisting of carbon nanotube, carbon nanofiber and carbon blacks such as acetylene black (AB) and furnace black. Of them, from the viewpoint of electron conductivity, the electroconductive material may be at least one selected from the group consisting of carbon nanotube and carbon nanofiber. The carbon nanotube and carbon nanofiber may be vapor-grown carbon fiber (VGCF). As the metal particles, examples include, but are not limited to, particles of Ni, particles of Cu, particles of Fe and particles of SUS.

The content of the electroconductive material in the cathode layer is not particularly limited.

As the binder, examples include, but are not limited to, acrylonitrile-butadiene rubber (ABR), butadiene rubber (BR), polyvinylidene fluoride (PVdF) and styrene-butadiene rubber (SBR). The content of the binder in the cathode layer is not particularly limited.

The thickness of the cathode layer is not particularly limited.

The cathode layer can be formed by a conventionally-known method.

For example, a cathode layer slurry is produced by putting the cathode active material and, as needed, other components in a solvent and mixing them. The cathode layer slurry is applied on one surface of a support such as the cathode current collector. The applied slurry is dried, thereby forming the cathode layer.

As the solvent, examples include, but are not limited to, butyl acetate, butyl butyrate, heptane and N-methyl-2-pyrrolidone.

The method for applying the cathode layer slurry on one surface of the support such as the cathode current collector, is not particularly limited. As the method, examples include, but are not limited to, a doctor blade method, a metal mask printing method, an electrostatic coating method, a dip coating method, a spray coating method, a roller coating method, a gravure coating method and a screen printing method.

The support may be appropriately selected from self-supporting supports, and it is not particularly limited. For example, a metal foil such as Cu and Al may be used as the support.

The cathode layer may be formed by another method such as pressure-forming a powdered cathode mix that contains the cathode active material and, as needed, other components. In the case of pressure-forming the powdered cathode mix, generally, a press pressure of about 1 MPa or more and about 600 MPa or less is applied.

The pressure applying method is not particularly limited. As the method, examples include, but are not limited to, pressing by use of a plate press machine, a roll press machine or the like.

As the cathode current collector, a conventionally-known metal that is usable as a current collector in all-solid-state batteries, may be used. As the metal, examples include, but are not limited to, a metal material containing one or more elements selected from the group consisting of Cu, Ni, Al, V, Au, Pt, Mg, Fe, Ti, Co, Cr, Zn, Ge and In.

The form of the cathode current collector is not particularly limited. As the form, examples include, but are not limited to, various kinds of forms such as a foil form and a mesh form.

The form of the whole cathode is not particularly limited. It may be a sheet form. In this case, the thickness of the whole cathode is not particularly limited. It can be determined depending on desired performance.

### Solid Electrolyte Layer

The solid electrolyte layer contains at least a solid electrolyte.

As the solid electrolyte contained in the solid electrolyte layer, a conventionally-known solid electrolyte that is usable in all-solid-state batteries, can be appropriately used. As such a solid electrolyte, examples include, but are not limited to, a solid electrolyte that can be incorporated in the above-described cathode layer.

As the solid electrolyte, one or more kinds of solid electrolytes may be used. In the case of using two or more kinds of solid electrolytes, they may be mixed together, or they may be formed into layers to obtain a multi-layered structure.

The proportion of the solid electrolyte in the solid electrolyte layer is not particularly limited. For example, it may be 50 mass % or more, may be in a range of 60 mass % or more and 100 mass % or less, may be in a range of 70 mass % or more and 100 mass % or less, or may be 100 mass %.

From the viewpoint of exerting plasticity, etc., a binder can be incorporated in the solid electrolyte layer. As the binder, examples include, but are not limited to, a binder that can be incorporated in the above-described cathode layer. However, the content of the binder in the solid electrolyte layer may be 5 mass % or less, from the viewpoint of, for example, preventing excessive aggregation of the solid electrolyte and making it possible to form the solid electrolyte layer in which the solid electrolyte is uniformly dispersed, for the purpose of easily achieving high power output.

The thickness of the solid electrolyte layer is not particularly limited. It is generally 0.1 μm or more and 1 mm or less.

As the method for forming the solid electrolyte layer, examples include, but are not limited to, pressure-forming a powdered solid electrolyte material that contains the solid electrolyte and, as needed, other components. In the case of pressure-forming the powdered solid electrolyte material, generally, a press pressure of about 1 MPa or more and about 600 MPa or less is applied.

The pressing method is not particularly limited. As the method, examples include, but are not limited to, those exemplified above in the formation of the cathode layer.

As needed, the all-solid-state battery comprises an outer casing for housing the cathode, the anode and the solid electrolyte layer.

The material for the outer casing is not particularly limited, as long as it is a material that is stable in electrolytes. As the material, examples include, but are not limited to, resins such as polypropylene, polyethylene and acrylic resin.

The all-solid-state battery may be an all-solid-state lithium secondary battery.

As the form of the all-solid-state battery, examples include, but are not limited to, a coin form, a laminate form, a cylindrical form and a square form.

### 2. All-Solid-State Battery Production Method

### 2-1. First Embodiment

The all-solid-state battery production method of the first embodiment is a method for producing the all-solid-state battery, the method comprising:

forming a Mg metal layer containing a magnesium metal on one surface of the anode current collector or on one surface of the solid electrolyte layer,

forming a battery precursor comprising the anode current collector, the Mg metal layer, the solid electrolyte layer and a cathode layer in this order, the cathode layer containing a cathode active material containing a lithium element, and

charging the battery precursor to form the Mg metal layer into a Li—Mg alloy layer containing a single β-phase alloy of a lithium metal and a magnesium metal.

The production method of the first embodiment comprises at least (1) the Mg metal layer forming step, (2) the battery precursor forming step and (3) the battery precursor charging step.

### (1) Mg Metal Layer Forming Step

This is a step of forming a Mg metal layer containing a magnesium metal on one surface of the anode current collector or on one surface of the solid electrolyte layer.

The anode current collector and the solid electrolyte layer will not be described here, since they are the same as those described above in “1. All-solid-state battery”.

For the magnesium metal used to form the Mg metal layer, the purity is not needed to be 100 atomic %. The magnesium metal may be a magnesium metal containing an impurity element.

The Mg metal layer may be formed by, for example, evaporating the magnesium metal on one surface of the anode current collector or on one surface of the solid electrolyte layer, using an electron beam evaporation device. From the viewpoint of the ease of forming the Mg metal layer, the Mg metal layer may be formed on one surface of the anode current collector.

### (2) Battery Precursor Forming Step

This is a step of forming a battery precursor comprising the anode current collector, the Mg metal layer, the solid electrolyte layer and a cathode layer in this order, the cathode layer containing a cathode active material containing a lithium element.

The cathode active material containing the lithium element and the cathode layer will not be described here, since they are the same as those described above in “1. All-solid-state battery”. In the case of the production method of the first embodiment, since the Li source of the all-solid-state battery is the lithium element contained in the cathode active material, the cathode active material containing the lithium element is used in the battery precursor forming step of the production method of the first embodiment.

In the formation of the battery precursor, the time for disposing the cathode layer is not particularly limited. The cathode layer may be disposed on one surface of the solid electrolyte layer before the Mg metal layer forming step described above, or the cathode layer may be disposed on the opposite side of the solid electrolyte layer to the side where the Mg metal layer is disposed, after the Mg metal layer forming step.

### (3) Battery Precursor Charging Step

This is a step of charging the battery precursor to form the Mg metal layer into a Li—Mg alloy layer containing a single β-phase alloy of a lithium metal and a magnesium metal.

The charging condition is not particularly limited. The charging time, etc., may be appropriately controlled depending on the thickness of the Mg metal layer, etc.

The Li—Mg alloy layer obtained in the battery precursor charging step corresponds to the anode layer described above in “1. All-solid-state battery”.

The all-solid-state battery production method of the first embodiment may be as follows, for example. First, the solid electrolyte layer is formed by pressure-forming a powdered solid electrolyte material. Next, the cathode layer is obtained by pressure-forming a powdered cathode mix that contains the cathode active material containing the lithium element on one surface of the solid electrolyte layer. Then, using the electron beam evaporation device, the Mg metal layer containing the magnesium metal is formed on the opposite surface of the solid electrolyte layer to the surface on which the cathode layer is formed. Accordingly, a cathode layer-solid electrolyte layer-Mg metal layer assembly is obtained. As needed, a current collector is attached to the assembly. Accordingly, the battery precursor is obtained. By charging the battery precursor, lithium ions transferred from the cathode layer to the Mg metal layer are reacted with the magnesium metal contained in the Mg metal layer. By the reaction, the anode layer containing the single β-phase alloy of the lithium metal and the magnesium metal, is obtained. The resulting product may be used as the all-solid-state battery of the disclosed embodiments.

In this case, the press pressure applied for pressure-forming the powdered solid electrolyte material and the powdered cathode mix, is generally about 1 MPa or more and about 600 MPa or less.

The pressing method is not particularly limited. As the pressing method, examples include, but are not limited to, those exemplified above in the formation of the cathode layer.

### 2-2. Second Embodiment

The all-solid-state battery production method of the second embodiment is a method for producing the all-solid-state battery, the method comprising:

forming a Li—Mg alloy layer on one surface of the anode current collector or on one surface of the solid electrolyte layer, the Li—Mg alloy layer containing a single β-phase alloy of a lithium metal and a magnesium metal, and disposing the anode current collector, the Li—Mg alloy layer, the solid electrolyte layer, and a cathode layer containing a cathode active material in this order.

The all-solid-state battery production method of the second embodiment comprises at least (A) the Li—Mg alloy layer forming step and (B) the disposing step.

### (A) Li—Mg Alloy Layer Forming Step

This is a step of forming a Li—Mg alloy layer on one surface of the anode current collector or on one surface of the solid electrolyte layer, the Li—Mg alloy layer containing a single β-phase alloy of a lithium metal and a magnesium metal.

The anode current collector and the solid electrolyte layer will not be described here, since they are the same as those described above in “1. All-solid-state battery”.

The Li—Mg alloy layer obtained in the Li—Mg alloy layer forming step corresponds to the anode layer described above in “1. All-solid-state battery”.

For the Li—Mg alloy used to form the Li—Mg alloy layer, from the viewpoint of increasing the cycle characteristics of the all-solid-state battery and suppressing an increase in the resistance of the all-solid-state battery even if the all-solid-state battery is produced in an oxygen-containing atmosphere, the percentage of the lithium element in the alloy may be 96.92 atomic % or more and 99.97 atomic % or less.

The percentage of the Mg element in the Li—Mg alloy may be from 0.1 mass % to 10 mass %.

The Li—Mg alloy layer may be formed by, for example, evaporating the Li—Mg alloy on one surface of the anode current collector or on one surface of the solid electrolyte layer, using the electron beam evaporation device. From the viewpoint of the ease of forming the Li—Mg alloy layer, the Li—Mg alloy layer may be formed on one surface of the anode current collector.

### (B) Disposing Step

This is a step of disposing the anode current collector, the Li—Mg alloy layer, the solid electrolyte layer, and a cathode layer containing a cathode active material in this order.

The cathode active material and the cathode layer will not be described here, since they are the same as those described above in “1. All-solid-state battery”. In the case of the production method of the second embodiment, since the Li source of the all-solid-state battery may be the lithium element contained in the Li—Mg alloy, in addition to the cathode active material containing the lithium element, the above-described cathode active material not containing the lithium element may be used in the disposing step of the production method of the second embodiment.

In the disposing step, the time for disposing the cathode layer is not particularly limited. The cathode layer may be disposed on one surface of the solid electrolyte layer before the Li—Mg alloy layer forming step described above, or the cathode layer may be disposed on the opposite side of the solid electrolyte layer to the side where the Li—Mg alloy layer is disposed, after the Li—Mg alloy layer forming step.

Since the Mg element is not present in the interface between the anode layer and the anode current collector and is present in the interface between the solid electrolyte layer and the anode layer, lithium ions are easily and uniformly diffused when the all-solid-state battery is charged and discharged.

However, in the production method of the first embodiment, since the magnesium metal is formed on one surface of the anode current collector or on one surface of the solid electrolyte layer, the surface of the thus-formed Mg metal layer is oxidized to form a Mg oxide layer. Once the Mg oxide layer is formed, the Mg element is not sufficiently diffused in the interface between the solid electrolyte layer and the anode layer, and the effect of increasing the charge-discharge efficiency of the all-solid-state battery with respect to the percentage of the Mg element in the Li—Mg alloy, may be small.

Meanwhile, it is suggested that the Mg element is easily diffused in the interface between the solid electrolyte layer and the anode layer in the case where, like the production method of the second embodiment, the Li—Mg alloy layer is formed in advance on one surface of the anode current collector or on one surface of the solid electrolyte layer and disposed between the anode current collector and the solid electrolyte layer at the time of assembling the all-solid-state battery, compared to the case where, like the production method of the first embodiment, the Mg metal layer is formed on one surface of the anode current collector or on one surface of the solid electrolyte layer and disposed between the anode current collector and the solid electrolyte layer, and then the battery precursor is charged to form the Mg metal layer into the Li—Mg alloy layer. Accordingly, even if the percentage of the Mg element in the Li—Mg alloy is decreased, lithium ions can be uniformly diffused when the all-solid-state battery is charged and discharged, and the charge-discharge efficiency of the all-solid-state battery is increased. In addition, by reducing the percentage of the Mg element in the Li—Mg alloy, the energy density of the all-solid-state battery is increased.

The sulfide-based solid electrolyte is known to show such a phenomenon that when it is brought into contact with the Li metal, phosphorus (P) in the sulfide-based solid electrolyte is reduced to Li₃P, and the Li₃P serves as a resistance layer. Meanwhile, like the production method of the second embodiment, in the case of forming the Li—Mg alloy layer in advance on one surface of the anode current collector or on one surface of the solid electrolyte layer at the time of assembling the all-solid-state battery, the formation of the Li₃P on the surface of the solid electrolyte layer by the contact with Li, is suppressed, and an increase in the resistance of the interface between the solid electrolyte layer and the anode layer, is suppressed.

Also, the Li metal reacts with the air to form Li₂CO₃. In the all-solid-state battery, the Li₂CO₃ serves as a resistance layer and causes a short circuit, deterioration, etc., by charge and discharge of the all-solid-state battery.

Accordingly, the all-solid-state battery comprising the anode in which the Li metal is used as the anode active material, is needed to be produced in an inert gas atmosphere such as Ar and results in poor productivity.

Meanwhile, like the production method of the second embodiment, in the case of forming the Li—Mg alloy layer in advance on one surface of the anode current collector or on one surface of the solid electrolyte layer at the time of assembling the all-solid-state battery, the formation of the Li₂CO₃ on the surface of the Li—Mg alloy layer is suppressed even if the Li—Mg alloy layer is exposed to an oxygen-containing gas atmosphere such as a dry atmosphere (dew point −30° C.), and just a thin, low-resistance, Li—Mg—O-containing layer is thought to be formed on the Li—Mg alloy layer surface exposed to the oxygen-containing gas.

### EXAMPLES

### Example 1

Using an electron beam evaporation device, a magnesium metal was evaporated to a thickness of 30 nm on one surface of a Cu foil, thereby forming a magnesium metal layer.

As a sulfide-based solid electrolyte, 101.7 mg of a Li₂S—P₂S₅-based material containing LiBr and LiI was prepared. The sulfide-based solid electrolyte was pressed at a pressure of 6 ton/cm², thereby obtaining a solid electrolyte layer (thickness 500 μm).

Next, a Li metal foil (thickness 150 μm) was disposed on one surface of the solid electrolyte layer. The Cu foil having the magnesium metal layer formed on one surface thereof, was disposed on the opposite surface of the solid electrolyte layer to the surface on which the Li metal foil was disposed, to ensure that the solid electrolyte layer and the magnesium metal layer were in contact with each other. They were pressed at a pressure of 1 ton/cm², thereby forming an evaluation battery 1 comprising the Li metal foil, the solid electrolyte layer, the magnesium metal layer and the Cu foil in this order.

### Example 2

An evaluation battery 2 was obtained in the same manner as Example 1, except that using the electron beam evaporation device, the magnesium metal was evaporated to a thickness of 100 nm on one surface of the Cu foil.

### Example 3

An evaluation battery 3 was obtained in the same manner as Example 1, except that using the electron beam evaporation device, the magnesium metal was evaporated to a thickness of 1000 nm on one surface of the Cu foil.

### Example 4

An evaluation battery 4 was obtained in the same manner as Example 1, except that using the electron beam evaporation device, the magnesium metal was evaporated to a thickness of 5000 nm on one surface of the Cu foil.

### Comparative Example 1

An evaluation battery 5 was obtained in the same manner as Example 1, except that the magnesium metal layer was not formed on one surface of the Cu foil.

### Charge-Discharge Test 1

The evaluation battery 1 was left to stand for one hour in a thermostat bath at 25° C. to uniform the temperature of the inside of the evaluation battery 1.

Next, the evaluation battery 1 was charged at a constant current with a current density of 435 μA/cm² to form, in the interface between the solid electrolyte layer and the magnesium metal layer, an anode layer containing a single β-phase alloy obtained by a reaction of the magnesium metal of the magnesium metal layer and lithium ions that were formed by the dissolution of the Li metal foil and then transferred to the magnesium metal layer side through the solid electrolyte layer. The charging of the evaluation battery 1 was terminated when the charge capacity of the evaluation battery 1 reached 4.35 mAh/cm². Accordingly, the evaluation battery 1 became an all-solid-state lithium secondary battery comprising the anode layer containing the single β-phase alloy of the lithium metal and the magnesium metal. After 10 minutes passed, the evaluation battery 1 was discharged at a constant current with a current density of 435 μA/cm² to dissolve the Li metal of the alloy. The discharging of the evaluation battery 1 was terminated when the voltage of the evaluation battery 1 reached 1.0 V.

The charge-discharge efficiency of the evaluation battery 1 was obtained by the following formula.

Charge-discharge efficiency (%)=(Discharge capacity/Charge capacity)×100

Then, the time between the start of the charging and the end of the discharging was determined as one cycle, and a total of 10 cycles of charging and discharging were repeated. The average charge-discharge efficiency of the evaluation battery 1 was calculated from the thus-obtained charge-discharge efficiencies of the evaluation battery 1. The result is shown in Table 1.

The average charge-discharge efficiency of the evaluation battery 2 was calculated in the same manner as the evaluation battery 1.

The average charge-discharge efficiency of the evaluation battery 3 was calculated as follows. First, the evaluation battery 3 was charged and discharged for 10 cycles to alloy all the magnesium metal of the magnesium metal layer with the lithium metal. Then, the evaluation battery 3 was charged and discharged for another 10 cycles (i.e., a total of 20 cycles). The average charge-discharge efficiency of the evaluation battery 3 was calculated from the charge-discharge efficiencies of the 11th to 20th cycles.

The average charge-discharge efficiency of the evaluation battery 4 was calculated as follows. First, the evaluation battery 4 was charged and discharged for 20 cycles to alloy all the magnesium metal of the magnesium metal layer with the lithium metal. Then, the evaluation battery 4 was charged and discharged for another 10 cycles (i.e., a total of 30 cycles). The average charge-discharge efficiency of the evaluation battery 4 was calculated from the charge-discharge efficiencies of the 21th to 30th cycles.

The average charge-discharge efficiency of the evaluation battery 5 was calculated from the charge-discharge efficiencies of the 1st to 4th cycles, since a short circuit occurred in the 5th cycle.

The results are shown in Table 1.

### The Percentage of the Li Element in the Alloy

For the evaluation batteries 1, 2 and 5, the percentage of the lithium element in the alloy contained in the anode layer of the fully charged battery just after the charging of the 1st cycle, was calculated by the below-described method. As a result, the alloy was confirmed to be the single β-phase alloy.

For the evaluation battery 3, the percentage of the lithium element in the alloy contained in the anode layer of the fully charged battery just after the charging of the 10th cycle, was calculated by the below-described method. As a result, the alloy was confirmed to be the single β-phase alloy.

For the evaluation battery 4, the percentage of the lithium element in the alloy contained in the anode layer of the fully charged battery just after the charging of the 20th cycle, was calculated by the below-described method. As a result, the alloy was confirmed to be the single β-phase alloy.

The results are shown in Table 1.

The percentage of the lithium element in the alloy was calculated as follows.

First, the mole number of the lithium metal was obtained, which corresponded to the deposition capacity of the lithium metal.

The atomic weight of the lithium metal was 6.941 g/mol. The theoretical capacity of the lithium metal was determined as 3861 mAh/g. The deposition capacity of the lithium metal was determined as C.

From the above, the mass (g) of the lithium metal was (C/3861). Accordingly, the mole number of the lithium metal was calculated from the following: (C/3861)/6.941.

Next, the mole number of the Mg metal was obtained.

The density of the Mg metal was 1.738 g/cm³. The atomic weight of the Mg metal was 24 g/mol. The area of the magnesium metal layer was determined as S. The thickness of the magnesium metal layer was determined as D.

From the above, the mass (g) of the Mg metal was (1.738×S×D). Accordingly, the mole number of the Mg metal was calculated from the following: [(1.738×S×D)/24].

Accordingly, the percentage (atomic %) of the lithium element in the alloy was obtained by the following calculation formula: “[the mole number of the lithium metal/(the mole number of the lithium metal+the mole number of the Mg metal)]×100”.

TABLE 1

| | | Percentage (atomic %) | |
|---|---|---|---|
| | | of the Li element in | |
| | Thickness | the alloy contained | Average charge- |
| | (nm) of the Mg | in the fully charged | discharge |
| | metal layer | evaluation battery | efficiency (%) |
| Example 1 | 30 | 99.80 | 98.7 |
| Example 2 | 100 | 99.50 | 99.4 |
| Example 3 | 1000 | 96.80 | 99.9 |
| Example 4 | 5000 | 81.80 | 98.6 |
| Comparative | — | 100.00 | 97.3 |
| Example 1 | | | |

### Evaluation Result 1

The average charge-discharge efficiency of the evaluation battery 5 of Comparative Example 1, the battery comprising the anode layer in which only the lithium metal was contained as the anode active material and the single β-phase alloy of the lithium metal and the magnesium metal was not contained, is 97.30%.

The average charge-discharge efficiencies of the evaluation batteries 1 to 4 of Examples 1 to 4, each comprising the anode layer in which the single β-phase alloy of the lithium metal and the magnesium metal was contained as the anode active material, are higher than the average charge-discharge efficiency of the evaluation battery 5 of Comparative Example 1. Especially, for the evaluation battery 3 of Example 3 in which the percentage of the Li element in the alloy contained in the anode layer of the fully charged battery was 96.80 atomic %, the average charge-discharge efficiency is 99.90% and high, and the battery characteristics are excellent.

Accordingly, it was proved that the all-solid-state battery with high charge-discharge efficiency is provided by the disclosed embodiments.

### Example 5

### Production of Li—Mg Alloy Foil

A Li—Mg alloy was subjected to injection molding, and the resulting product was roll-pressed to a thickness of 100 μm, thereby obtaining a Li—Mg alloy foil.

The composition of elements contained in the Li—Mg alloy foil was quantitated by inductively coupled plasma atomic emission spectroscopy.

As a result, the following were found: the percentage of the Li element in the Li—Mg alloy foil was 99.97 atomic %; the mass percentage of the Mg was 0.1 mass %; the Li—Mg alloy foil contained 0.2 mass % of impurity elements; and the impurity elements were Na, K, Ca, Fe and N.

### Production of Evaluation Battery

(1) An oxide layer was removed from the surface of the Li—Mg alloy foil; the Li—Mg alloy foil was pressed by a roller to a thickness of 80 μm; the Li—Mg alloy foil was exposed for 24 hours in the Ar atmosphere glove box; and the Li—Mg alloy foil was formed in a square of 1 cm². A total of two Li—Mg alloy foils formed in a square of 1 cm² were produced.

(2) As a sulfide-based solid electrolyte, 101.7 mg of a Li₂S—P₂S₅-based material was prepared. The sulfide-based solid electrolyte was pressed at a pressure of 6 ton/cm², thereby obtaining a solid electrolyte layer with a cross-sectional area of 1 cm² (thickness 500 μm).

(3) The solid electrolyte layer was sandwiched between the two Li—Mg alloy foils formed in the 1 cm² square, thereby forming a laminate A comprising the Li—Mg alloy foil, the solid electrolyte layer and the Li—Mg alloy foil in this order. Two Ni foils were prepared, and the laminate A was sandwiched between the two Ni foils, thereby forming a laminate B comprising the Ni foil, the Li—Mg alloy foil, the solid electrolyte layer, the Li—Mg alloy foil and the Ni foil in this order. The laminate B was pressed at a pressure of 1 ton/cm².

(4) The laminate B was confined at 0.6 Nm, thereby obtaining an evaluation battery A. The evaluation battery A was put in a separable flask, and the flask was hermetically closed.

The above processes (1) to (4) were carried out inside an Ar-filled glove box.

### Charge-Discharge Test 2

The evaluation battery A was left to stand for three hours in a thermostat bath at 60° C. to uniform the temperature of the inside of the evaluation battery A.

A current with a current density of 0.1 mA/cm² was passed through the evaluation battery A. From the resulting response voltage, the initial resistance of the evaluation battery A was obtained.

Charging and discharging at a constant current with a current density of 0.5 mA/cm² were determined as one cycle, and the evaluation battery A was charged and discharged for a total of 100 cycles.

After the charging and discharging for 100 cycles, a current with a current density of 0.1 mA/cm² was passed through the evaluation battery A. From the resulting response voltage, the resistance of the evaluation battery A after the 100 cycles was obtained.

The resistance increase rate of the evaluation battery A after the 100 cycles was calculated by the following formula, using the initial resistance of the evaluation battery A and the resistance of the evaluation battery A after the 100 cycles. The result is shown in Table 2.

Resistance increase rate (%) after 100 cycles=(Resistance after 100 cycles/Initial resistance)×100

### Example 6

An evaluation battery B was produced in the same manner as Example 5, except that such a Li—Mg alloy foil was produced, that the percentage of the Li element and the mass percentage of the Mg were 99.86 atomic % and 0.5 mass %, respectively. The charge-discharge test 2 of the evaluation battery B was carried out in the same manner as Example 5. The result is shown in Table 2.

### Example 7

An evaluation battery C was produced in the same manner as Example 5, except that such a Li—Mg alloy foil was produced, that the percentage of the Li element and the mass percentage of the Mg were 99.71 atomic % and 1 mass %, respectively. The charge-discharge test 2 of the evaluation battery C was carried out in the same manner as Example 5. The result is shown in Table 2.

### Example 8

An evaluation battery D was produced in the same manner as Example 5, except that such a Li—Mg alloy foil was produced, that the percentage of the Li element and the mass percentage of the Mg were 99.12 atomic and 3 mass %, respectively. The charge-discharge test 2 of the evaluation battery D was carried out in the same manner as Example 5. The result is shown in Table 2.

### Example 9

An evaluation battery E was produced in the same manner as Example 5, except that such a Li—Mg alloy foil was produced, that the percentage of the Li element and the mass percentage of the Mg were 99.52 atomic % and 5 mass %, respectively. The charge-discharge test 2 of the evaluation battery E was carried out in the same manner as Example 5. The result is shown in Table 2.

### Example 10

An evaluation battery F was produced in the same manner as Example 5, except that such a Li—Mg alloy foil was produced, that the percentage of the Li element and the mass percentage of the Mg were 96.92 atomic % and 10 mass %, respectively. The charge-discharge test 2 of the evaluation battery F was carried out in the same manner as Example 5. The result is shown in Table 2.

### Comparative Example 2

An evaluation battery G was produced in the same manner as Example 5, except that in place of the Li—Mg alloy foil, such a lithium metal foil was prepared, that the percentage of the Li element was 100 atomic %. The charge-discharge test 2 of the evaluation battery G was carried out in the same manner as Example 5. The result is shown in Table 2.

TABLE 2

| | | | Resistance increase |
|---|---|---|---|
| | | | rate (%) after 100 |
| | Li (atomic %) | Mg (mass %) | cycles |
| Comparative | 100 | 0 | 115.9 |
| Example 2 | | | |
| Example 5 | 99.97 | 0.1 | 104.3 |
| Example 6 | 99.86 | 0.5 | 101.1 |
| Example 7 | 99.71 | 1 | 103.5 |
| Example 8 | 99.12 | 3 | 105.6 |
| Example 9 | 99.52 | 5 | 109.2 |
| Example 10 | 96.92 | 10 | 110.0 |

### Evaluation Result 2

As shown in Table 2, the resistance increase rates of Examples 5 to 10 are low compared to Comparative Example 2. Example 6 for which the percentage of the Li element was 99.86 atomic %, showed the highest resistance increase suppressing effect.

Accordingly, it was proved that the all-solid-state battery configured to suppress an increase in resistance induced by charge-discharge cycles, is provided by the disclosed embodiments.

### Example 11

An evaluation battery (a) was produced in the same manner as Example 5, except that in the process (1) of “Production of evaluation battery”, the Li—Mg alloy foil was exposed for 24 hours in a dry atmosphere glove box kept at a dew point of −30° C., instead of being exposed for 24 hours in the Ar atmosphere glove box.

### Impedance Evaluation

The evaluation battery (a) was left to stand for 3 hours in a thermostat bath at 25° C. to uniform the temperature of the inside of the evaluation battery (a).

Impedance evaluation of the evaluation battery (a) was carried out at an applied voltage of 10 mV and in a measurement range of from 1 MHz to 1 mHz, thereby measuring the resistance of the Li—Mg foil surface exposed to the dry atmosphere.

For comparison, impedance evaluation of the evaluation battery A of Example 5 was carried out in the same condition as the evaluation battery (a), thereby measuring the resistance of the Li—Mg foil surface exposed to the Ar atmosphere.

The diameter of an arc obtained from complex impedance plots includes, in addition to the resistance of the interface between the solid electrolyte layer and the Li—Mg foil, the intragranular resistance and grain boundary resistance of the solid electrolyte particles. Provided that the solid electrolyte-derived resistances of the evaluated batteries are the same, the resistances of the evaluation batteries A and (a), each of which was obtained from the diameter of the arc, were compared to each other, and the resistance increase rate induced by the exposure to the dry atmosphere was calculated by the following formula. The result is shown in Table 3.

Resistance increase rate (%) induced by exposure to dry atmosphere=(Resistance of Li—Mg foil exposed to dry atmosphere/Resistance of Li—Mg foil exposed to Ar atmosphere)×100

### Example 12

An evaluation battery (b) was produced in the same manner as Example 6, except that in the process (1) of “Production of evaluation battery”, the Li—Mg alloy foil was exposed for 24 hours in a dry atmosphere glove box kept at a dew point of −30° C., instead of being exposed for 24 hours in the Ar atmosphere glove box. Then, impedance evaluation of the evaluation battery (b) and the evaluation battery B of Example 6 was carried out in the same manner as Example 11. Using the thus-obtained resistances of the evaluation batteries B and (b), a resistance increase rate induced by the exposure to the dry atmosphere was calculated by the above formula. The result is shown in Table 3.

### Example 13

An evaluation battery (c) was produced in the same manner as Example 7, except that in the process (1) of “Production of evaluation battery”, the Li—Mg alloy foil was exposed for 24 hours in a dry atmosphere glove box kept at a dew point of −30° C., instead of being exposed for 24 hours in the Ar atmosphere glove box. Then, impedance evaluation of the evaluation battery (c) and the evaluation battery C of Example 7 was carried out in the same manner as Example 11. Using the thus-obtained resistances of the evaluation batteries C and (c), a resistance increase rate induced by the exposure to the dry atmosphere was calculated by the above formula. The result is shown in Table 3.

### Example 14

An evaluation battery (d) was produced in the same manner as Example 8, except that in the process (1) of “Production of evaluation battery”, the Li—Mg alloy foil was exposed for 24 hours in a dry atmosphere glove box kept at a dew point of −30° C., instead of being exposed for 24 hours in the Ar atmosphere glove box. Then, impedance evaluation of the evaluation battery (d) and the evaluation battery D of Example 8 was carried out in the same manner as Example 11. Using the thus-obtained resistances of the evaluation batteries D and (d), a resistance increase rate induced by the exposure to the dry atmosphere was calculated by the above formula. The result is shown in Table 3.

### Example 15

An evaluation battery (e) was produced in the same manner as Example 9, except that in the process (1) of “Production of evaluation battery”, the Li-Mg alloy foil was exposed for 24 hours in a dry atmosphere glove box kept at a dew point of −30° C., instead of being exposed for 24 hours in the Ar atmosphere glove box. Then, impedance evaluation of the evaluation battery (e) and the evaluation battery E of Example 9 was carried out in the same manner as Example 11. Using the thus-obtained resistances of the evaluation batteries E and (e), a resistance increase rate induced by the exposure to the dry atmosphere was calculated by the above formula. The result is shown in Table 3.

### Example 16

An evaluation battery (f) was produced in the same manner as Example 10, except that in the process (1) of “Production of evaluation battery”, the Li-Mg alloy foil was exposed for 24 hours in a dry atmosphere glove box kept at a dew point of −30° C., instead of being exposed for 24 hours in the Ar atmosphere glove box. Then, impedance evaluation of the evaluation battery (f) and the evaluation battery F of Example 10 was carried out in the same manner as Example 11. Using the thus-obtained resistances of the evaluation batteries F and (f), a resistance increase rate induced by the exposure to the dry atmosphere was calculated by the above formula. The result is shown in Table 3.

### Comparative Example

An evaluation battery (g) was produced in the same manner as Comparative Example 2, except that in the process (1) of “Production of evaluation battery”, the Li—Mg alloy foil was exposed for 24 hours in a dry atmosphere glove box kept at a dew point of −30° C., instead of being exposed for 24 hours in the Ar atmosphere glove box. Then, impedance evaluation of the evaluation battery (g) and the evaluation battery G of Comparative Example 2 was carried out in the same manner as Example 11. Using the thus-obtained resistances of the evaluation batteries G and (g), a resistance increase rate induced by the exposure to the dry atmosphere was calculated by the above formula. The result is shown in Table 3.

TABLE 3

| | | | Resistance increase |
|---|---|---|---|
| | | | rate (%) by exposure |
| | Li (atomic %) | Mg (mass %) | to dry atmosphere |
| Comparative | 100 | 0 | 108.70 |
| Example 3 | | | |
| Example 11 | 99.97 | 0.1 | 104.90 |
| Example 12 | 99.86 | 0.5 | 100.10 |
| Example 13 | 99.71 | 1 | 99.05 |
| Example 14 | 99.12 | 3 | 94.41 |
| Example 15 | 99.52 | 5 | 93.42 |
| Example 16 | 96.92 | 10 | 101.60 |

### Evaluation Result 3

As shown in Table 3, the resistance increase rates induced by the exposure to the dry atmosphere of Examples 11 to 16 are low compared to Comparative Example 3. Example 15 for which the percentage of the Li element was 99.52 atomic %, showed the highest resistance increase suppressing effect. Examples 12 to showed almost no increase in the resistance or showed a decrease in the resistance.

Accordingly, it was proved that even if the all-solid-state battery is produced under the oxygen-containing gas atmosphere, an increase in the resistance of the all-solid-state battery is suppressed by the disclosed embodiments.

### REFERENCE SIGNS LIST

11. Solid electrolyte layer
12. Cathode layer
13. Anode layer
14. Cathode current collector
15. Anode current collector
16. Cathode
17. Anode
100. All-solid-state battery

1. An all-solid-state battery,
wherein a lithium metal precipitation-dissolution reaction is used as an anode reaction;
wherein the all-solid-state battery comprises a cathode comprising a cathode layer, an anode comprising an anode current collector and an anode layer, and a solid electrolyte layer disposed between the cathode layer and the anode layer;
wherein the anode layer contains, as an anode active material, a single β-phase alloy of a lithium metal and a magnesium metal; and
wherein a percentage of the lithium element in the alloy is 81.80 atomic % or more and 99.97 atomic % or less when the all-solid-state battery is fully charged.

2. A method for producing the all-solid-state battery defined by claim 1, the method comprising:
forming a Mg metal layer containing a magnesium metal on one surface of the anode current collector or on one surface of the solid electrolyte layer,
forming a battery precursor comprising the anode current collector, the Mg metal layer, the solid electrolyte layer and a cathode layer in this order, the cathode layer containing a cathode active material containing a lithium element, and
charging the battery precursor to form the Mg metal layer into a Li—Mg alloy layer containing a single β-phase alloy of a lithium metal and a magnesium metal.

3. A method for producing the all-solid-state battery defined by claim 1, the method comprising:
forming a Li—Mg alloy layer on one surface of the anode current collector or on one surface of the solid electrolyte layer, the Li—Mg alloy layer containing a single β-phase alloy of a lithium metal and a magnesium metal, and
disposing the anode current collector, the Li—Mg alloy layer, the solid electrolyte layer, and a cathode layer containing a cathode active material in this order.

4. The method for producing the all-solid-state battery according to claim 3, wherein a percentage of the lithium element in the alloy is 96.92 atomic % or more and 99.97 atomic % or less.

5. The all-solid-state battery according to claim 1, wherein the percentage of the lithium element in the alloy is 81.80 atomic % or more and 99.80 atomic % or less.

6. The method for producing the all-solid-state battery according to claim 2, wherein a thickness of the Mg metal layer is from 100 nm to 1000 nm.
